(19) United States
(12) Patent Application Publication
(10) Pub. No.: US 2003/0096575 A1
(43) Pub. Date: May 22, 2003

(54) Radio coverage in closed environments

(76) Inventor: Walter Harold William Tuttlebee, Romsey (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/149,708

(22) PCT Filed: Dec. 12, 2000
(86) PCT No.: PCT/GB00/04775

(30) Foreign Application Priority Data
Dec. 15, 1999 (GB) 9929489.4

(51) Int. Cl. H04B 3/36; H04B 7/14

(52) U.S. Cl. 455/15; 455/7

(57) ABSTRACT

An electronic component comprising a module which in a preferred embodiment has external dimensions corresponding to those of a standard building brick or block, or to an assembled combination of such bricks or blocks, so that use of the said module in the construction of partitions such as walls or floors, comprising such bricks or blocks is thereby facilitated, the module including parts which facilitate the transmission there through of radio signals.

This invention relates to electronic components and more especially it relates to electronic radio components for use in the building and or civil engineering industries.

During the 1990's commercial cellular radio service applications have developed from the mobile phone, which was designed primarily use in vehicles, to the smaller personal telephone, which might normally accompany a person wherever they go. Also, during this time, operating frequencies have increased from VHF, to 900 MHz, to 2 GHz, and even higher frequencies are likely in the future. These two factors, i.e. ‘a use anywhere requirement’, and ‘increasingly high operating frequencies’, have created problems with maintaining good in-building communications due primarily to radio signal screening effects. With the advent of satellite personal phones, third generation (3G) systems such as UMTS, and subsequent systems (fourth generation, 4G) the need is for good in-building coverage, and this will become even more important and moreover these requirements might also apply in some cases to wireless broadcast services, such as radio and television services.

It is an important object of this invention to provide electronic components for use by the building industry which serve largely to obviate this problem.

According to the present invention an electronic component for use in the building or civil engineering industries comprises a module including parts which facilitate the transmission there through of radio signals.

The module may have external dimensions which correspond to those of a standard building brick or block, or to a contiguous plurality of such bricks or blocks so that use of the said module in the construction of partitions such as walls or floors, comprising such bricks or blocks is thereby facilitated.

According to one aspect of the invention the said parts may define a passive electronic component.

The passive electronic component may comprise two external faces which each embody an antenna or the like, the antennas being mutually coupled so as to facilitate the transmission therebetween, from one face to the other, of radio signals.

The two faces may be mutually juxtaposed, so that in use, the passage therebetween of radio signals is facilitated, from one room to another, or from outside of a building to within its walls.

The antenna or the like may comprise wave guides, lenses, dipoles or any required combination of these or similar elements.

According to another aspect of the invention, the said parts may define an active electronic component.

The active electronic component may, in accordance with one embodiment, comprise a module having two faces which each embody an antenna or the like, an amplifier which serves to couple the antennas, and electrical connector means via which electrical operating power is in use supplied to the amplifier.

The amplifier may include a remotely controllable gain control circuit responsive to radio control signals radiated to set the gain of the amplifier.

The active component may in accordance with another embodiment, comprise a module which includes an RF input socket and an RF amplifier so that RF input signals may be injected via the RF socket to the RF amplifier thereby to produce output signals for radiation by antennas which are embodied in faces of the module.

Some embodiments of the present invention will now be described by way of example with reference to the accompanying drawings in which;

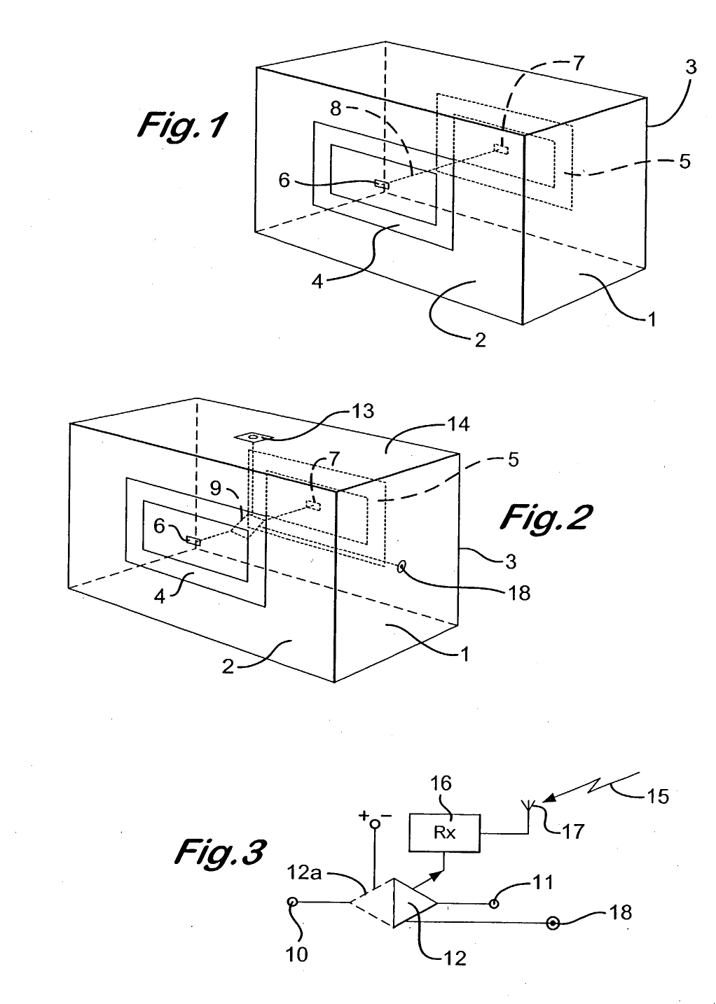

FIG. 1, is a perspective view of a passive electronic component suitable for use in the building industry;

FIG. 2, is a perspective view of an active electronic component suitable for use in the building industry and;

FIG. 3, is a somewhat schematic block circuit diagram of a part of the active component shown in FIG. 2.

Referring now to FIG. 1, a modular electronic component, herein called a ‘Bricksat’, comprises a housing 1, fabricated from plastics or any other suitable robust material having external dimensions which correspond to those of a standard building block (e.g. blocks such as those sold under the trade marks Celcon or Brieze) which are commonly used in the building industry. On juxtaposed faces 2, 3, of the housing 1, a pair of similar printed antennas 4, 5, are provided, the size and shape of which are determined in dependence upon operating frequency. Although in this example a simple slot antenna is shown, the antennas may alternative comprise dipoles, or phased arrays, or embedded lens antennas to afford directionality as required by the particular application in view. The antennas 4,5, may thus take various forms, as will be appreciated by those skilled in the art, which will not therefore be individually described in detail herein.

The ‘Bricksat’ shown in FIG. 1, is a passive component and accordingly centrally disposed connection pads 6,7, of the antennas 4,5, are simply linked by means of a conductor 8 thereby to provide a low loss path between the faces 2,3, of the housing 1, for radio signals within a chosen frequency band of operation.

Thus it will be appreciated that if one or more ‘Bricksats’ are built into a partition between two rooms, the passage of radio signals therebetween in this chosen band is thereby facilitated.

Referring now to FIG. 2, wherein parts corresponding to those shown in FIG. 1 bear the same numerical designations, a ‘Bricksat’ is shown which comprises an amplification unit 9, which is used instead of the conductor 8, shown in FIG. 1, to link the antennas 4,5 and which accordingly is an active component.

The unit 9, is shown in greater detail in FIG. 3, and comprises a pair of terminals 10, 11, which are connected to the pads 6,7, respectively and which are coupled by a gain controlled amplifier 12, which receives electrical operating power from an external power supply (not shown) via a power supply connector 13, provided in one face 14, of the housing 3. As indicated by the broken lines 12a, the amplifier may be either uni-directional or bi-directional as required, so as to provide amplification between the terminals 10,11, either in one direction or in both directions. The gain of the amplifier !2/12a, may optionally be controlled or pre-set by means of a radio control signal 15, received by a ‘blue tooth’ or similar radio receiver 16 via an antenna 17.

Although the arrangement thus far described with reference to FIGS. 2 and 3, is primarily intended for use as a signal repeater, which can be used in the construction of a building to improve signal reception therein, (in rooms which might otherwise suffer poor reception due to screening effects) it is contemplated that in some cases signals might be fed via cables to an active ‘Bricksat’, say from a distribution amplifier, which could then serve to radiate distributed signals within a building so as to provide the signal coverage required. In order to provide for this additional facility an RF input socket 18, is optionally provided via which input RF signals can be fed to the amplifiers, 12,12a, to be radiated from antennas connected to the terminals 11, and 10, respectively.

The ‘Bricksat’ concept thus relates to active or passive radio repeaters, manufactured in the form of civil engineering construction products (like bricks) and sold through such distribution chains, which will facilitate better in-building operation of wireless telephone, satellite communication and terrestrial/satellite wireless broadcast services.

The concept of the ‘Bricksat’ will thus serve to provide a low cost radio repeater device which can be sold as a medium-value building construction product, through builders' merchants or DIY outlets, for incorporation into new buildings or as a retrofit to old ones. ‘Bricksats’ would allow the in-building coverage of such personal communication (and other) radio systems to be enhanced as a simple DIY activity for the home-owner, as well as better coverage to be designed in by the architect when a new building is first conceived. Different models are envisaged corresponding to different wireless systems—e.g. 900 MHz GSM, 1800 MHz GSM, 2 GHz US PCS, Iridium/satcom, digital satellite TV, etc.

The external mechanical construction of the ‘Bricksat’ devices would be robust and could be identical in dimensions (or multiples thereof) to standard conventional building products (Brieze blocks, bricks, etc.) so that ‘Bricksats’ can be designed into the building by the architect, subject to suitable rules, at the building design stage. ‘Bricksats’ could also be incorporated as retrofits, should this be desired, in existing buildings, in a more ad hoc manner, by homeowners wishing to improve their in-home cellphone or wireless entertainment service coverage. (With the prospect of wireless replacing wired phones as the norm in the future the former could become a very important market).

It is apparent that the passive ‘Bricksat’ is envisaged as a non-powered unit comprising, for example, tuned antennas on opposite (external and internal facing) faces of the device, providing a low-loss ‘tunnel’ for the radio waves through the wall of the building. Variations to provide higher gain performance could be envisaged e.g. fitting points to allow microwave lenses to be attached or printed phased array antennas (to give directionality), arrays of ‘Bricksats’ (to give improved gain), etc.

An alternative concept of the passive ‘Bricksat’ would embody the use of waveguide techniques/properties, perhaps by moulding the device from two plastics with differing dielectric properties, thereby providing a very low cost construction technique for the devices.

A further variation could be a device whose construction and physical properties are engineered to provide, at the frequency of interest, increased diffraction around corners. This could, for example, be mounted at the edges of windows to increase the diffraction of signals in and out of a room.

The active ‘Bricksat’ would preferably be an externally powered unit containing suitable wide band amplification in addition to the features of the passive ‘Bricksat’. These could support similar variations and could, in time, also provide dynamic directionality if required by providing dynamic control of printed phased array antennas. Mains powered active ‘Bricksats’ would require to be located in such a way as to allow access to power—they would perhaps be supplied with a power lead or standard electrical connection points. Once installed, the gain of active ‘Bricksats’ could be controlled remotely, either by means of signalling over the mains or by means of a short range wireless link (e.g. Bluetooth or IrDA) to a control receiver built into the ‘Bricksat’.

In an alternative embodiment, the ‘Bricksat’ could be powered by a solar panel backed by a rechargeable battery.

The ‘Bricksat’ could be envisaged as a uni-directional or bi-directional product.

A uni-directional product could provide improved in-building coverage for digital broadcast services—digital terrestrial TV, digital satellite TV/radio or digital audio broadcasting, for example. For cellular radio systems, with split operating bands for up and down link, it could be feasible perhaps to sell paired units which are mounted closely, one tuned for the up- and one for the down-link. Some systems would require full bi-directionality and would hence require a more complex technical solution.

An intermediate step to the full ‘Bricksat’ concept could be a low-cost repeater device with the same functionality as described above, but without the constraint of being engineered as a building construction product having the same dimensions as a standard brick or block.

1. A module for use in the building or civil engineering industries, wherein the module is fabricated from a robust material and has external dimensions which substantially correspond to those of a standard building brick or block, or to an assembled combination of such bricks or blocks, so that in use said module can be built into walls or floors, comprising such bricks or blocks, the module comprising an electronic component that enables radio signals to be transmitted through the module.

2. A module as claimed in claim 1, wherein the said electronic component is a passive electronic component.

3. A module as claimed in claim 2, wherein the module comprises two external faces and the electronic component comprises an antenna formed on each face, the antennas being mutually coupled so as to facilitate the transmission therebetween, from one face to the other, of radio signals.

4. A module as claimed in claim 3, wherein the two faces are mutually juxtaposed, so that in use, the passage therebetween of radio signals is facilitated, from one room to another, or from outside of a building to within its walls as the case may be.

5. A module as claimed in claim 1, wherein the said electronic component is an active electronic component.

6. A module as claimed in claim 5, wherein the module comprises two faces and the electronic component comprises an antenna formed on each face, an amplifier which serves to couple the antennas, and electrical connector means via which electrical operating power is in use supplied to the amplifier.

7. A module as claimed in claim 6, wherein the amplifier may include a remotely controllable gain control circuit responsive to radio control signals radiated to set the gain of the amplifier to a predetermined level.

8. A module as claimed in claim 5, wherein the active electronic component comprises RF input socket and an RF amplifier coupled so that RF input signals injected via the RF socket to the RF amplifier produce output signals for radiation by antennas which are embodied in faces of the module.

9. A module as claimed in any of claims 5 to 8, wherein the electronic component is powered by means of a power supply which includes a solar panel backed by a rechargeable battery.

10. A module as claimed in any preceding claim wherein the antenna comprises wave guides, lenses, dipoles or any required combination of these or elements.

11. A module as claimed in any preceding claim, wherein the electronic component is uni-directional.

12. A module as claimed in any preceding claim wherein the electronic component is arranged to be bi-directional.
